(19) United States
(12) Patent Application Publication
(10) Pub. No.: US 2010/0065211 A1
(43) Pub. Date: Mar. 18, 2010

(54) NONFOAMING 1-COMPONENT POLYURETHANE ADHESIVE COMPOSITION

(75) Inventors: Bernhard Gruenewaelder, Hilden (DE); Thomas Bachon, Duesseldorf (DE); Birgit Ness, Langenfeld (DE); Kerstin Schroeder, Grevenbroich (DE); Thomas Terveer, Viersen (DE)

Correspondence Address: HENKEL CORPORATION, One Henkel Way, ROCKY HILL, CT, 06067, US

(73) Assignee: Henkel AG & Co. KGaA

(21) Appl. No.: 12/520,491

(22) PCT Filed: Nov. 20, 2007
(86) PCT No.: PCT/EP07/62577

§ 371 Date: Nov. 20, 2009

(30) Foreign Application Priority Data
Dec. 21, 2006 (DE) 10 2006 061 787.8

(51) Int. Cl. B32B 37/12; C09J 175/04

(52) U.S. Cl. 156/331.1; 524/538

(57) ABSTRACT

The present invention provides a 1-component polyurethane adhesive composition based on at least one NCO-terminated polyurethane prepolymer, which comprises polyamide fibers and at least 10% by weight of fillers.

The subject matter of the present invention is a 1-component polyurethane adhesive composition based on at least one NCO-terminated polyurethane prepolymer, which comprises polyamide fibers and at least 10 wt. % of fillers.

In this application, the data in wt. % basically refer to the total composition unless otherwise stated.

One-component reactive polyurethane systems in liquid, thixotropic or paste form are known from the prior art. The main field of application of this type of adhesive system is in the field of constructive adhesion, in which the aim concerns compounds with the highest possible strength and a high degree of heat resistance and water resistance, such as for example in the adhesive bonding of wood for external applications.

One-component polyurethane adhesives are continually more frequently used, particularly in the field of wood adhesion, because they have considerable advantages against polyvinyl acetate dispersions in regard to heat and water stability. However, in order to ensure a durable and stable adhesive bond with the one-component polyurethane adhesives, it is particularly required that once the adhesive has been applied, the work piece being adhesively bonded remain at the position for which it is intended, without slipping or becoming detached. Any detachment would immediately produce a defective bond, as either the work piece becomes completely detached or the slipping produces a decrease in strength, which considerably reduces the quality of the adhesive bond. Consequently, when gluing with one-component polyurethane adhesives, such as those known for example from DE 101 23 620 A1, clamping tools are employed, such as e.g. screw clamps, brackets, presses or the like, in order to prevent any slipping of the work piece until the adhesive has cured. With the one-component polyurethane adhesive systems known up to now, what is worse is that considerable amounts of carbon dioxide are formed during curing, causing the adhesive to foam and thereby reduces the cohesion within the adhesive layer so strongly that even with initially highly viscous adhesive systems, the use of the abovementioned clamping tools is imperative. Finally, this is also required on visual grounds, as for visible adhesive joints these should be as thin as possible and thereby unobtrusive.

Even if, due to the position of the substrates being glued, it would not be absolutely necessary to fasten them, e.g. when two work pieces are glued horizontally to one another, the foaming of the 1-component polyurethane adhesive during the curing nevertheless leads to the irreversible formation of a foam structure within the adhesive layer which considerably worsens the mechanical properties of the adhesive bond, in particular its tensile shear strength.

Accordingly, the object of the present invention was to make a one-component polyurethane adhesive system, with which mechanically stable and durable adhesive bonds can be achieved without the use of mechanical clamping tools for fastening the freshly glued substrates together.

It was surprisingly found that one-component polyurethane adhesive systems, which already comprise at least about 10 wt. % of fillers, could be modified by the addition of polyamide fibers such that they practically no longer foam during curing.

Beech wood crossbars having the dimensions 360 mm×40 mm×20 mm were used for the quantitative testing of the foaming behavior. Six holes (0=10 mm, depth=10 mm), spaced 50 mm apart, were each located centrally in the 40 nm wide surface.

Under standardized climatic conditions the adhesive was introduced by means of a cartridge pistol into the holes of the abovementioned test specimens and immediately smoothed out with a spatula. The test specimens prepared in this way were then left for 24 hours under the same climatic conditions.

After 24 hours, the height of the adhesive that had escaped out of the hole was determined with a thickness measurement instrument. The arithmetic mean of 6 measurements was given as a percentage of the depth of the hole. The results are given in %.

In order to achieve the best possible reproducibility, the beech wood crossbars were conditioned in a standardized climate for at least 7 days because the moisture present in the wood strongly affects the measurement result. Likewise, the adhesive to be tested was also stored at a temperature of 23° C.

According to the invention, “almost non-foaming adhesive compositions during curing” are understood to mean compositions that show a foam behavior in the above-described methods of less than 45%, preferably less than 35%, particularly preferably less than 30%.

Foaming of the adhesive by the released carbon dioxide that results from the curing step is the main reason that the substrates, once freshly bonded together, must be fastened together by means of clamping tools or the like until the completion of curing. Because the addition of polyamide fibers to such adhesive systems can almost totally repress foaming in the adhesive during curing, the use of clamping tools for fastening the bonded parts is unnecessary.

Accordingly, the subject matter of the present invention is a 1-component polyurethane adhesive composition based on at least one NCO-terminated polyurethane prepolymer, said composition comprising polyamide fibers and at least 10 wt. % of fillers.

In the context of the present invention, an NCO-terminated polyurethane prepolymer (PU prepolymer) is understood to mean a compound that is manufactured from at least one polyol compound and at least one polyisocyanate, and which after the reaction possesses a content of non reacted NCO-groups in the range 8 to 22 wt. % based on the prepolymer, preferably 12 to 15 wt. % based on the prepolymer. The NCO-content is generally controlled by the excess of NCO groups of the polyisocyanate components in relation to the OH groups of the polyol compound. Preparative methods for such prepolymers are known to the person skilled in the art.

The polyol component for manufacturing the PU prepolymers should comprise at least one polyol. Suitable polyols can be: polyester polyols—e.g. the polyester Desmophen 1700 (Bayer) from adipic acid and diethylene glycol, or a polyester manufactured from adipic acid, isophthalic acid and diethylene glycol or a polyester manufactured from adipic acid, isophthalic acid, propylene glycol and diethylene glycol—as well as polyether polyols, e.g. polyethylene glycol and polypropylene glycol.

According to the invention, polyols with a high molecular weight are particularly suitable because the viscosity of the polyurethane prepolymer prepared from them can be kept low. Consequently, the molecular weight of the polyols should be from 1 000 to 12 000, preferably between 2 000 and 8 000 and especially between 3 000 and 6 000 g/mol.

The polyisocyanate component for manufacturing the PU prepolymer should comprise at least one polyisocyanate. It can be both aliphatic as well as cycloaliphatic and especially aromatic. Preferred isocyanates are: MDI, polymeric MDI, IPDI, TDI and TMXDI.

The viscosity of the PU prepolymer at 23° C. should be in the range 500 to 25 000, preferably in the range 2 000 to 10 000 and especially in the range 3 000 to 7 000 mPas, measured according to Brookfield (spindle 6/20 rpm).

The composition according to the invention further comprises at least 10 wt. % of fillers. Their purpose consists in inter alia to increase the volume and/or the weight or the density, as well as to influence the rheology of the adhesive system. However, they can also improve the industrial applicability, e.g. reducing the shrinkage or to influence the hardness, the strength and the flexibility. They can also serve as colorants. These fillers principally include carbonates, especially calcium carbonate, but also silicates, especially sand, talc, clay and mica, and sulfates, especially calcium sulfate and barium sulfate, as well as aluminum hydroxide, glass and carbon blacks. In addition to these inorganics, organic materials can also be considered, e.g. wood flour, bark meal or cereal flour, as well as cellulose, pulp or rice hull powder or powdered cotton linter. Mixtures of different fillers can also be employed.

The inventively claimed minimum fraction of fillers of ca. 10 wt. % is firstly required in order to match the density or the viscosity of the polyurethane prepolymer such that after blending with the polyamide fibers, demixing does not occur between the fibers and the prepolymer component. It was, however determined that with filler contents below about 10 wt. %, the inventive effect of foam repression by the polyamide fibers decreases. A possible explanation of this could be that the resulting density difference between fibers and the remainder of the composition leads to demixing that worsens the foam repression of the polyamide fibers. Consequently, should prepolymers and polyamide fibers have a similar density or should they not demix in a mixture and thereby remain storage stable, then it would also be conceivable to manufacture a one-component polyurethane adhesive without having to add fillers.

The inventively added polyamide fibers can consist for example of Nylon or Perlon, but also of compact polyamides, such as e.g. Akulon or of aromatic polyamides, such as e.g. Aramid. Fibers of polyamide 6.6 with a fiber length of 1.0 mm and a titer of 3.3 dtex are particularly suitable in the context of the present invention.

The indicated titer values for fibers were determined according to DIN EN ISO 1973 and are established according to the equation Tt=m/n l) with Tt=titer [dtex], m=weight of the fiber bundle [mg], n=fiber count and l=fiber length [mm].

According to a preferred embodiment of the present invention, the content of polyurethane prepolymer in the composition according to the invention is between 30 and 80 wt. % based on the total composition, preferably between 40 and 60 wt. %. This is particularly advantageous, as these quantities of polyurethane prepolymer firstly allow good final strengths to be achieved and secondly, allow the costs of such an adhesive to be kept moderate.

According to a particularly preferred embodiment of the present invention, the viscosity at 23° C. of the polyurethane prepolymer is between 500 and 25 000 MPas, preferably 2 000 to 10 000 MPas, especially 3 000 to 7 000 MPas, measured according to Brookfield (spindle, 6/20 rpm). The viscosity of the polyurethane prepolymer is quite particularly preferably about 4 000 MPas. This is particularly advantageous, because with viscosities in this range the resulting adhesive composition has firstly a sufficient cohesion and tenacity which prevent any running or dripping of the adhesive after it has been applied and immediately fixes the bonded parts, but secondly enables it to be applied by squeezing it out of a cartridge or tube. Moreover, the viscosities in the above-cited ranges prevent any demixing in the case of density differences between the polyurethane prepolymer and the polyamide fibers likewise added to the inventive adhesive system, which would considerably reduce the storage stability of an adhesive packaged in a tube or a cartridge where stirring before use is impossible.

According to another particularly preferred embodiment of the present invention, the NCO content of the polyurethane prepolymer is between 8 and 22 wt. %, especially between 12 and 15 wt. %, based on the polyurethane prepolymer. This is particularly advantageous, as adhesive systems containing a polyurethane prepolymer of the indicated NCO contents show an adequate setting rate with a simultaneously good final strength. Moreover, with the above-cited NCO contents, due to the inventive addition of the polyamide fibers, practically no gas bubble formation occurs within the adhesive layer when curing the adhesive.

According to a preferred embodiment of the present invention, the content of fillers in the composition according to the invention is between 20 and 65 wt. %, preferably between 35 and 55 wt. % based on the 1-component polyurethane adhesive composition. This is particularly advantageous because by adding fillers in these quantities, the processability and final strength of the adhesive system are particularly good. Moreover, the volume shrinkage on curing the adhesive can be reduced by the addition of fillers. Finally, the content of polyurethane prepolymer can be reduced by the addition of fillers in these quantities, thereby allowing the total adhesive composition to be manufactured more cheaply.

According to another preferred embodiment of the present invention, the polyol component for manufacturing the polyurethane prepolymer comprises at least one polyol from the group consisting of polyester polyol and polyether polyol, wherein the average molecular weight of the polyols is in the range 1 000 to 12 000 g/mol, preferably 2 000 to 8 000 g/mol, especially 3 000 to 6 000 g/mol. This is particularly advantageous, as high molecular weight polyols lower the viscosity of the polyurethane prepolymer. Polypropylene glycols are more suitable than polyethylene glycols for manufacturing the polyurethane prepolymers for the compositions according to the invention, as polyethylene glycols, due to their waxy consistency, mix less well with the other components and reduce the storage stability.

In particular, diols and trials are inventively employable polyols, the triols being particularly preferred, because polyurethane prepolymers based on them afford a higher strength adhesive bond on curing the inventive adhesive composition.

According to a particularly preferred embodiment of the composition according to the invention, the 1-component polyurethane adhesive composition comprises at least 0.5 wt. % of polyamide fibers, based on the total composition. This is particularly advantageous, as such a polyamide fiber content strongly reduces the foam formation without simultaneously modifying the rheological properties of the adhesive composition too strongly. A readjustment of existing formulations without polyamide fibers is therefore only possible by making great efforts to adapt the usual constituents, especially in regard to thickeners or thixotropes.

According to another preferred embodiment of the composition according to the invention, the 1-component polyurethane adhesive composition comprises up to 10 wt. %, preferably up to 6 wt. %, quite particularly preferably, especially between 1.5 and 4 wt. % of polyamide fiber. This is particularly advantageous, as such a fraction of polyamide fibers in the composition according to the invention almost completely prevents the formation of carbon dioxide bubbles during curing of the adhesive and therefore the formation of foam in the bond, and in addition does not modify the rheological properties of the adhesive composition, especially the viscosity, with the result that the adhesive can still be pressed out of a cartridge or a tube. Accordingly, the addition of the polyamide fibers firstly controls the desired processing consistency of the 1-component polyurethane adhesive and thereby simultaneously prevents foaming during curing of the adhesive when bonding components.

According to a particularly preferred embodiment of the composition according to the invention, the length of the polyamide fibers is 0.1 to 7 mm, especially 0.5 to 2 mm and their diameter is 10 to 100 μm, especially 15 to 35 μm. This is particularly advantageous, as polyamide fibers with these dimensions prevent particularly well the formation of carbon dioxide bubbles in the adhesive and thereby the foaming during curing.

According to another preferred embodiment of the composition according to the invention, the titer of the polyamide fibers is 1 to 100 dtex, especially 2 to 20 dtex. This is particularly advantageous, as polyamide fibers with such a titer almost completely prevent the formation of carbon dioxide bubbles in the adhesive during curing. Polyamide fibers with a titer of this type can be added in comparatively small amounts that on the one hand suffice to almost completely prevent the formation of carbon dioxide bubbles in the adhesive during curing and on the other hand do not increase the viscosity of the adhesive system enough that the adhesive can no longer be applied from a tube or a cartridge.

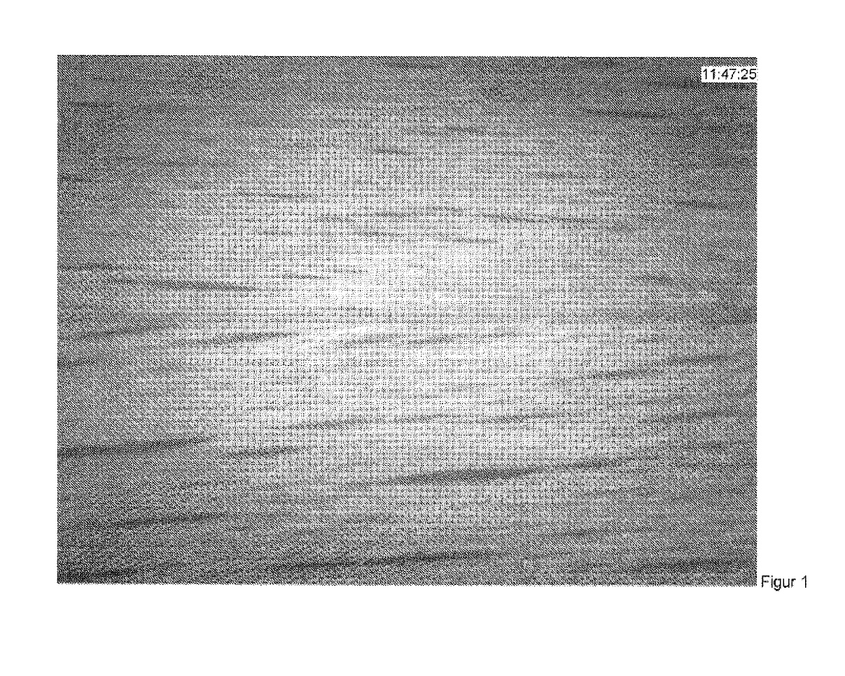

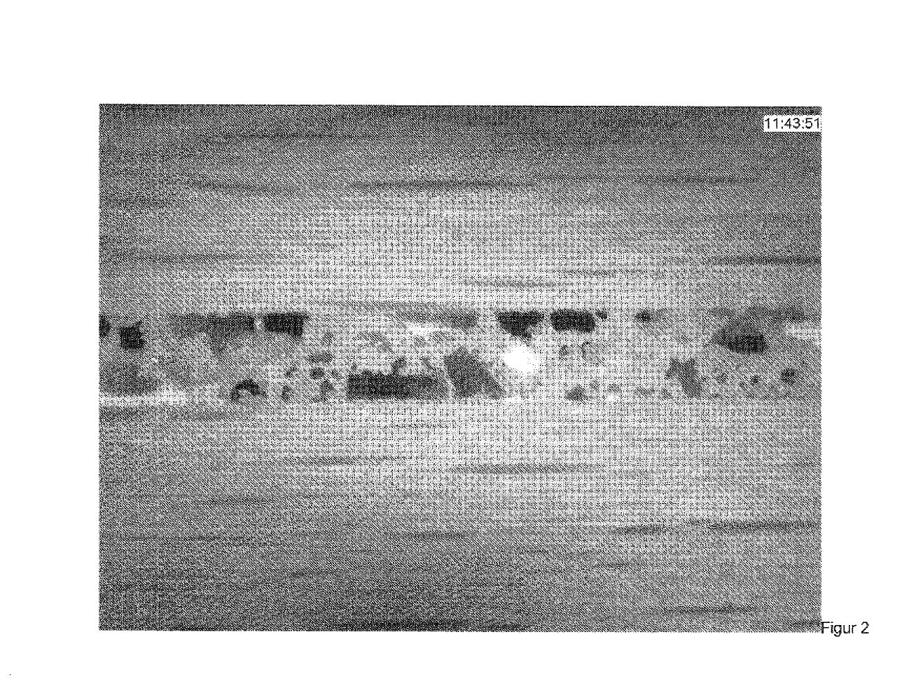

According to another preferred embodiment of the composition according to the invention, the polyamide fibers are selected from Nylon, Perlon, Akulon and Aramid fibers. Nylon 6.6 polyamide fibers are quite particularly preferred. This is particularly advantageous, as polyamide fibers made of these materials are particularly suited to almost completely repress the formation of carbon dioxide bubbles and thereby a foaming of the adhesive during curing. This can be clearly seen in both of the FIGS. (1) and (2). In both cases, two wood test specimens of copper beech were adhesively bonded with a 1-K polyurethane adhesive: in FIG. 1) with an inventive adhesive formulation and in FIG. 2) with a commercial 1-component polyurethane adhesive, i.e. without polyamide fibers. The adhesive coating was ca. 175 g/m². After coating by hand with both the adhesives, the parts to be bonded were placed one on top of the other on a horizontal surface and left to cure without clamps, collars etc. After curing, the adhesive joint was cut for a better visual evaluation. The foamed adhesive joint caused by escaping carbon dioxide can be clearly observed in the adhesive bond in FIG. 2. In contrast, the adhesive bond with the inventive adhesive remains free of bubbles and essentially narrower and less visible.

According to another embodiment, the composition according to the invention comprises 0 to 10 wt. % of auxiliaries, based on the total composition, which are selected from the group comprising thickeners, thixotropes, catalysts, defoamers, wetting agents, stabilizers, colorants, lightweight fillers, optical brighteners, solvents and UV absorbers. Suitable exemplary thickeners are urea derivatives such as e.g. the products from the Byk company.

Thixotropes produce a plastic flow behavior. That means that up to stress levels below the yield stress or flow limit, the PU adhesive behaves as a solid and as such is e.g. elastically deformable. The PU adhesive then begins to flow when the shear stress exceeds a defined value (yield stress). Then the shear rate increases with the reduced shear stress around the yield stress or flow limit. The shear rate-dependent viscosity change should however be as independent as possible from the shear time, in order that the viscosity can return to the original value practically without a break when the shear stress is absent. In this context, a suitable thixotrope is highly dispersed silica, used at an addition level of ca. 2 to 8, above all 3 to 7 and especially 4 to 6 wt. %, based on the prepolymer.

Highly dispersed silica is understood to mean in particular pyrogenic silica that was manufactured by flame hydrolysis. The highly dispersed silica should be predominantly hydrophobic. This is the case only when it is wetted by a methanol and water mixture, whose methanol fraction is more than 50 vol. %.

Mainly, tertiary amines or organometallic compounds such as e.g. iron, titanium or tin compounds are suitable catalysts.

Silicone oils such as e.g. Perenol 3270 from Cognis are suitable defoamers.

Fatty chemical ester compounds such as e.g. Sovermol 1055 from Cognis are the principal wetting agents.

Principal stabilizers are acid chlorides such as e.g. benzoyl chloride.

Principal colorants are iron oxides or organic pigments.

Suitable lightweight fillers are expanded organic polymers such as e.g. products from EKA Chemicals or foamed glass such as e.g. Glass Bubbles from the 3M company.

On environmental and industrial safety considerations, the inventive 1-component polyurethane adhesive is essentially free of solvent. However, it can comprise up to 5 wt. %, preferably up to 2.5 wt. %, especially up to 1 wt. % of solvent, based on the total composition, for example in order to influence the rheological behavior or the open time or the processing time. Technically, adhesive compositions according to the invention can likewise be made without problem with solvent fractions of up to 20 wt. %. As above, they possess the inventive effects of non-foaming during curing but are not preferred on the above-cited environmental and sanitary grounds. A solvent is regarded as an inert substance that is liquid at room temperature and has a boiling point below 200° C. under normal pressure. Typical solvents are ethers, esters, ketones as well as cycloaliphatic or aromatic hydrocarbons.

The 1-component polyurethane adhesive is predominantly free of plasticizers. Up to 5 wt. % at most, based on the total composition, can be comprised. Examples of plasticizers under consideration are esters such as phthalates, pure or mixed ethers or end-blocked polyethylene glycols.

Furthermore, the 1-component polyurethane adhesive according to the invention is predominantly free of water. Up to 1 wt. % at most, based on the total composition, can be comprised.

Examples of UV stabilizers that can be employed in the adhesive composition according to the invention are the so-called hindered amine light stabilizers.

According to a particularly preferred embodiment of the composition according to the invention, the 1-component polyurethane adhesive hardly foams at all during curing when bonding substrates. This is particularly advantageous, as consequently, after the substrates to be bonded have been joined together and pressed together, they do not need to be sustainably compressed by clamps or similar tools until the adhesive has completely cured in order to achieve a strong and permanent adhesive bonding of the work pieces.

Another subject matter of the present invention is a process for manufacturing a 1-component polyurethane adhesive composition, in which at least one NCO-terminated polyurethane prepolymer, prepared from at least one polyol compound and at least one polyisocyanate, is mixed with polyamide fibers and at least 10 wt. % of fillers, based on the total composition.

Another subject matter of the present invention is the use of polyamide fibers in a 1-component polyurethane adhesive composition that comprises at least 10 wt. % of fillers for reducing the foam formation during curing. This is particularly advantageous, as the almost complete repression of foam formation or generation of carbon dioxide bubbles during the curing of the adhesive means that due to the cohesion of the still uncured adhesive, the work pieces that are freshly bonded together remain in their position without the need for being fastened together by means of clamps or similar clamping tools.

Another subject matter of the present invention is an adhesion process for the almost bubble-free adhesion of substrates with a 1-component polyurethane adhesive composition, in which a first surface to be adhesively bonded is coated with the adhesive composition, is pressed onto the second surface to be adhesively bonded, and the adhesive is then left to cure without the use of clamps or presses.

According to a preferred embodiment of the adhesion process according to the invention, the resulting adhesive bond of two beech wood test specimens, without the assistance of bonding pressure (from collars, clamps), exhibits a tensile shear strength of at least 2.0 N/mm², preferably more than 2.5 N/mm², in particular more than 3.0 N/mm², quite particularly preferably more than 3.5 N/mm².

Semi-rigid beech woods with the dimensions: l=8 cm×w=5 cm×h=0.5 cm were used for testing the tensile shear strength.

Under standardized climatic conditions the adhesive was applied by means of a cartridge pistol in strands onto the wide side of the test specimen along half the length, and a second test specimen was placed, with a 4 cm overlap, onto the horizontally placed test specimen that had been provided with adhesive and was joined by hand until the adhesive visibly emerged from the joints. The adhesion occurred without clamping tools, i.e. without compression. The resulting adhesion surface was 50 mm×40 mm and the total length of the whole test specimen was 120 mm.

After 24 hours cure in the standard climate (23° C./50% relative humidity), the test specimens were tensile tested with a testing machine (Instron, model 4302) (pulling speed 50 mm/min) and the maximum value at break determined. An average value was determined from 5 test measurements.

Another subject matter of the present invention is the use of the adhesive composition according to the invention for adhesively bonding materials such as wood, wood materials, mineral substrates, metals, paper, cardboard, leather, fiber fleeces, natural fibers, synthetic fibers or plastics.

Test Methods:

Determination of the isocyanate content (NCO content):

According to EN 1242 of 01/2006, results in wt. %

Determination of Viscosity:

Brookfield Digital Viscometer RTVDV II spindle 6 at 23° C.

Viscosity measurement according to EN ISO 2555 of 01/2000

Results in mPas

Determination of the Water Content:

According to Karl Fischer

Results in ppm or %

Determination of the Foaming Behavior:

Beech wood crossbars having the dimensions 360 mm×40 mm×20 mm were used for testing the foaming behavior. Six holes (Ø=10 mm, depth=10 mm), spaced 50 mm apart, were each located centrally in the 40 mm wide surface.

Under standardized climatic conditions the adhesive was introduced by means of a cartridge pistol into the holes of the abovementioned test specimens and immediately smoothed out with a spatula. The test specimens prepared in this way were then left for 24 hours under the same climatic conditions.

After 24 hours, the height of the adhesive that had escaped out of the hole was determined with a thickness measurement instrument. The arithmetic mean of 6 measurements was given as a percentage of the depth of the hole. The results are given in %.

In order to achieve the best possible reproducibility, the beech wood crossbars were conditioned in a standardized climate for at least 7 days because the moisture present in the wood strongly affected the measurement results. Likewise, the adhesive to be tested was also stored at a temperature of 23° C.

Determination of the Erection Property:

Film coated plywood, 28 mm thick, (BFU with phenolic resin coating, Westag & Getalit AG) was used for testing the erection property. The plywood had the dimensions 20 cm×10 cm and a test specimen had the dimensions 7 cm×5 cm.

The plywood was fixed with the long width side standing perpendicular, with the rough side facing forward.

Under standardized climatic conditions the adhesive was applied by means of a cartridge pistol in strands onto the machined surface of the narrow side of the test specimen (A=50 mm×28 mm) and this was pressed horizontally by hand onto the perpendicularly standing plywood onto the rough side until the adhesive visibly emerged on the sides. The test specimen thus stuck out horizontally at the angle of 90° to the plywood.

After 24 hours under the same climatic conditions a test was then carried out to determine whether the test specimen had come away or was still in the same position as where it had been placed. There are thus two possible results:
same position: positive
slipped/fell down: negative

In order to achieve the best possible reproducibility, the film coated plywood (plywood and test specimen) were conditioned in a standardized climate for at least 7 days because the moisture present in the wood strongly affects the measurement results. Likewise, the adhesive to be tested was also stored at a temperature of 23° C.

The test enables an approximately practice-relevant statement to be made of whether an adhesive is suitable for the erection, as firstly the employed test specimen contributes a high dead weight in relation to its size, secondly the dimensions of the test specimen result in a high leveraged weight and thirdly the surface on which the test specimen is positioned is not smooth but rough.

Result: positive, negative

Tensile Shear Strength 1:

Semi-rigid beech woods with the dimensions: 1=8 cm×w=5 cm×h=0.5 cm were used for testing the tensile shear strength 1.

Under standardized climatic conditions the adhesive was applied by means of a cartridge pistol in strands onto the wide side of the test specimen along half the length, and a second test specimen was placed, with a 4 cm overlap, onto the horizontally placed test specimen that had been provided with adhesive and was joined by hand until the adhesive visibly emerged from the joints. The adhesion occurred without clamping tools, i.e. without compression. The resulting adhesion surface was 50 mm×40 mm and the total length of the whole test specimen was 120 mm.

After 24 hours cure in the standard climate, the test specimens were tensile tested with a testing machine (pulling speed 50 mm/min) and the maximum value determined. An average value was determined from 5 test measurements.

In order to achieve the best possible reproducibility, the beech wood was conditioned in a standardized climate for at least 7 days because the moisture present in the wood strongly affects the measurement result. Likewise, the adhesive to be tested was also stored at a temperature of 23° C.

Result in kilo Newton (kN)

Tensile Shear Strength 2:

Semi-rigid beech woods with the dimensions: l=8 cm×w=5 cm×h=0.5 cm were used for testing the tensile shear strength 2.

The test specimens were prepared as in the test tensile shear strength 1.

After 24 hours cure in the standard climate, the test specimens were stored for 3 hours under tap water at a temperature of 23° C.±1° C. and then when wet tensile tested with a testing machine (pulling speed 3 mm/min) and the maximum value determined. An average value was determined from 5 test measurements.

In order to achieve the best possible reproducibility, the beech wood was conditioned in a standardized climate for at least 7 days because the moisture present in the wood strongly affects the measurement result. Likewise, the adhesive to be tested was also stored at a temperature of 23° C.

### Result in kN

Tensile Shear Strength 3:

Semi-rigid beech woods with the dimensions: l=8 cm×w=5 cm×h=0.5 cm were used for testing the tensile shear strength 3.

The test specimens were prepared as in the test tensile shear strength 1.

After 24 hours cure in the standard climate, the test specimens were stored for 1 hour at 80° C.±1° C. in the circulating air drying oven and after removal within 10 seconds and still warm were tensile tested with a testing machine (pulling speed 1 mm/min) and the maximum value determined. An average value was determined from 5 test measurements.

In order to achieve the best possible reproducibility, the beech wood was conditioned in a standardized climate for at least 7 days because the moisture present in the wood strongly affects the measurement result. Likewise, the adhesive to be tested was also stored at a temperature of 23° C.

### Result in kN

Quantitative Determination of the MDI Positional Isomers (2,4-MDI Fraction)

By gas chromatography; results in %

Determination of the Yield Stress with an ARES Rheometer

The yield stresses were tested at 23° C., 24 hours after manufacturing the adhesive. Result in Pa

Preparation of test specimens for DIN EN 12765

DIN EN 205 from June 2003, determination of the adhesive strength of longitudinal adhesive bonds in a tensile test.

Heat stability according to DIN EN 14257 from September 2006 Results in N/mm²

Determination of water resistance according to DIN EN 12765 September 2001 (EN 12765: 2001)

Classifying thermoset wood adhesives for non-supporting applications. Testing with thin adhesive joint.

Tested claimed group: C4, results in N/mm²

Standardized climate DIN 50014: 23° C.±2° C. and 50% rel. humidity±3%.

PC-Laboratory system dissolver type LDV 1

PC Laborsystem GmbH, Mägden Switzerland

Instron model 4302 testing machine

Circulating air-drying oven type UT 6120

### EXAMPLES

### Example 1

### Preparation of the Prepolymer

112.8 g Lupranat MIS (MDI mixture of 50% 4,4 and 50% 2,4 MDI BASF, NCO content 33%) were placed in a stirred glass reactor at 50° C. under N₂ and 112.8 g Desmodur M 44 (4,4 MDI Bayer, NCO 33%) were added and homogeneously melted. The premixed, dewatered polyols with a water content <400 ppm consisting of 230.07 g Lupranol 1000 (polyether polyol Elastogran, OHZ 55) and 14.10 g Voranoi CP 450 (Polyether trial Brenntag, OHZ 380) were then metered in. After stirring for 5 minutes, the mixture was heated to 70° C. 0.23 g DBTL catalyst (dibutyltin dilaurate, Brenntag) was then added. Due to the enthalpy of reaction, the reactor temperature rose independently within two minutes to more than 95° C. This temperature should not be exceeded and when necessary cooling is required. The resulting prepolymer was then stirred at 80-85° C. until the theoretical NCO content of 12.9±0.3% was obtained. The product was then cooled to <40° C. under N₂.

A clear, light prepolymer was obtained with a viscosity of 2600 MPas at 23° C. measured according to Brookfield (spindle 6/20 rpm) and a practical NCO content of 12.7%. When needed, a minor fraction (<1000 ppm) of an acid chloride can be added to the prepolymer for the purpose of stabilization.

### Preparation of the Adhesive in an Evacuatable Dissolver:

The freshly prepared prepolymer was placed in a planetary dissolver at a temperature between 30° C. and 40° C. and 510 g barium sulfate (EWO powder, Sachtleben) was homogeneously incorporated. Mixing was continued for a further 30 minutes under N₂. 20 g Polyamide fiber Nylon 6.6 (STW Schenkelzell) was subsequently homogeneously incorporated and mixing was continued for a further 45 minutes at a temperature between 40° C. and 50° C. under vacuum. The resulting product was then filled bubble-free into a PE cartridge under inert gas. After a maturing time of ca. 24 hours at ca. 23° C. the product had almost reached its final properties. A slight increase in the yield stress or flow limit is generally still observed over the course of a few days.

### Example 1

### Adhesive Properties, Inventive

| Yield stress ARES rheometer | 960 | Pas |
|---|---|---|
| Foam behavior | 27% | |
| Erection properties | positive | |
| Tensile shear strength 1: | 8.4 | kN |
| Tensile shear strength 2: | 7.4 | kN |
| Tensile shear strength 3: | 5.8 | kN |

### Example 2

### Non-Inventive, Comparative Example

Prepolymer as in example 1 and adhesive preparation as in example 1 but without fibers and with 530 g barium sulfate.

### Adhesive Properties Example 2

| Yield stress ARES rheometer | 40 | Pas |
|---|---|---|
| Foam behavior | 95% | |
| Erection behavior | negative | |
| Tensile shear strength 1 | 4.1 | kN |
| Tensile shear strength 2 | 2.8 | kN |
| Tensile shear strength 3 | 2.7 | kN |

### Example 3

### Inventive

Prepolymer as in example 1 and adhesive preparation as in example 1 but with 10 g polyamide fibers Nylon 6.6 and with 520 g barium sulfate.

### Adhesive Properties Example 3

| Yield stress ARES rheometer | 405 | Pas |
|---|---|---|
| Foam behavior | 32% | |
| Erection properties | positive | |
| Tensile shear strength 1 | 8.0 | kN |
| Tensile shear strength 2 | 7.1 | kN |
| Tensile shear strength 3 | 5.5 | kN |

### Example 4

### Inventive

Prepolymer as in example 1 and adhesive preparation as in example 1 but with 30 g polyamide fibers Nylon 6.6 and with 500 g barium sulfate.

### Adhesive Properties Example 4

| Yield stress ARES rheometer | 1780 | Pas |
|---|---|---|
| Foam behavior | 20% | |
| Erection properties | positive | |
| Tensile shear strength 1 | 7.4 | kN |
| Tensile shear strength 2 | 7.2 | kN |
| Tensile shear strength 3 | 6.0 | kN |

### Example 5

### Non-Inventive, Comparative Example with Polyester Fiber

Prepolymer as in example 1 and adhesive preparation as in example 1 but with 20 g F PES 231/040 fibers (Polyester fiber STW Schenkelzell) with 520 g barium sulfate.

### Adhesive Properties Example 5

| Yield stress ARES rheometer | 445 | Pas |
|---|---|---|
| Foam behavior | 45% | |
| Erection properties | negative | |
| Tensile shear strength 1 | 5.6 | kN |
| Tensile shear strength 2 | 5.2 | kN |
| Tensile shear strength 3 | 4.2 | kN |

### Example 6

### Non-Inventive, Comparative Example with Polypropylene Fiber

Prepolymer as in example 1 and adhesive preparation as in example 1 but with 20 g F PP 261/040 fibers (Polypropylene fiber STW Schenkelzell) with 520 g barium sulfate.

### Adhesive Properties Example 6

| Yield stress ARES rheometer | 50 | Pas |
|---|---|---|
| Foam behavior | 65% | |
| Erection properties | negative | |
| Tensile shear strength 1 | 6.0 | kN |
| Tensile shear strength 2 | 5.9 | kN |
| Tensile shear strength 3 | 3.9 | kN |

### Example 7

### Non-Inventive, Comparative Example with Glass Fibers

Prepolymer as in example 1 and adhesive preparation as in example 1 but with 20 g FG 400/030 fibers (Glass fiber STW Schenkelzell) with 520 g barium sulfate.

### Adhesive Properties Example 7

| Yield stress ARES rheometer | 190 | Pas |
|---|---|---|
| Foam behavior | 61% | |
| Erection properties | negative | |
| Tensile shear strength 1 | 5.8 | kN |
| Tensile shear strength 2 | 5.2 | kN |
| Tensile shear strength 3 | 4.8 | kN |

### Example 8

### Non-Inventive, Comparative Example with Cotton Fibers

Prepolymer as in example 1 and adhesive preparation as in example 1 but with 20 g FB 1/035 fibers (Cotton fiber STW Schenkelzell) with 520 g barium sulfate.

### Adhesive Properties Example 8

| Yield stress ARES rheometer | 1900 | Pas |
|---|---|---|
| Foam behavior | 55% | |
| Erection properties | negative | |
| Tensile shear strength 1 | 4.8 | kN |
| Tensile shear strength 2 | 4.4 | kN |
| Tensile shear strength 3 | 3.8 | kN |

To underline that polyols with a higher molecular weight and a functionality of >2 also afford an improved reduction in foam, a trifunctional polyol with a molecular weight of 6000 was used in the following examples.

Formulation of Prepolymer 2:

109.0 g Lupranat MIS (MDI mixture of 50% 4,4 and 50% 2,4 MDI BASF, NCO content 33%) were placed in a stirred glass reactor at 50° C. under N₂ and 109.0 g Desmodur M 44 (4.4 MDI Bayer, NCO 33%) were added and homogeneously melted. 251.7 g of dewatered Accliam Polyol 6300—water content <400 ppm—(trifunctional polypropylene ether polyol Bayer, OHZ 28) were then added to the mixture. After stirring for 5 minutes, the mixture was heated to 70° C. 0.23 g Benzoyl chloride (benzoyl chloride 98% conc., Riedel-de-Haen) was then added as a stabilizer. After a further 5 minutes stirring, 0.23 g DBTL catalyst (Dibutyltin dilaurate, Brenntag) was added. Due to the enthalpy of reaction, the reactor temperature rose independently within a few minutes to more than 85° C. A temperature of 95° C. should not be exceeded and when necessary cooling is required. The resulting prepolymer was then stirred at 80-85° C. until the theoretical NCO content of 14.2%±0.3% was obtained. The product was then cooled to <40° C. under N₂.

A light yellowish cloudy prepolymer was obtained (hereafter called prepolymer 2) with a viscosity of 1950 mPas and a practical NCO content of 14.1%.

The adhesive was prepared (incorporation of the fillers and/or fibers) as in example 1 in an evacuatable dissolver, wherein the barium sulfate was always added first and the polyamide substrate was incorporated after appropriate stirring and evacuation. The adhesive without barium sulfate was prepared similarly. Depending on the consistency, the resulting product was filled under N₂ into a cartridge or into a water vapor-tight container.

### Example 9

### Non-Inventive, Comparative Example

Prepolymer 2

| Yield stress ARES rheometer | <50 Pas |
|---|---|
| Foam behavior | 58% |

### Example 10

### Non-Inventive, Comparative Example

Prepolymer 2 preparation as described above, then blended with 117.5 g barium sulfate.

| Yield stress ARES rheometer | <50 Pas |
|---|---|
| Foam behavior | 59% |

### Example 11

### Non-Inventive, Comparative Example

Prepolymer 2 preparation as described above, then blended with 9.6 g polyamide fiber.

| Yield stress ARES rheometer | <50 Pas |
|---|---|
| Foam behavior | 59% |

### Example 12

### Inventive

Prepolymer 2 preparation as described above, then blended with 120.5 g barium sulfate and 12.1 g polyamide fiber.

| Yield stress ARES rheometer | 125 Pas |
|---|---|
| Foam behavior | 47% |

### Example 13

### Inventive

Prepolymer 2 preparation as described above, then blended with 261.1 g barium sulfate and 14.9 g polyamide fiber.

| Yield stress ARES rheometer | 258 Pas |
|---|---|
| Foam behavior | 31% |

### Example 14

### Inventive

Prepolymer 2 preparation as described above, then blended with 489.6 g barium sulfate and 19.6 g polyamide fiber.

| Yield stress ARES rheometer | 595 Pas |
|---|---|
| Foam behavior | 24% |

### Example 15

### Non-Inventive, Comparative Example

Prepolymer 2 preparation as described above, then blended with 452.9 g barium sulfate and 26.6 g Disparlon 6500 (synthetic polyamide wax, Kusumoto Chemicals Ltd.).

| Yield stress ARES rheometer | 65 Pas |
|---|---|
| Foam behavior | 58% |

1. A 1-Component polyurethane adhesive composition based on at least one NCO-terminated polyurethane prepolymer, comprising polyamide fibers and at least 10 wt. % of fillers.

2. The composition according to claim 1, wherein the polyurethane prepolymer content is between 30 and 80 wt. %.

3. The composition according to claim 1, wherein the viscosity of the polyurethane prepolymer at 23° C. is between 500 and 25 000 mPas, measured according to Brookfield (spindle 6/20 rpm).

4. The composition according to claim 1, wherein the NCO content of the polyurethane prepolymer is between 8 and 22 wt. %.

5. The composition according to claim 1, wherein the filler content is between 20 and 65 wt. %.

6. The composition according to claim 1, wherein a polyol component for manufacturing the polyurethane prepolymer comprises at least one polyol from the group consisting of a polyester polyol and a polyether polyol, wherein the average molecular weight of the polyol is in the range 1 000 to 12 000 g/mol.

7. The composition according to claim 6, wherein the polyol component for manufacturing the polyurethane prepolymer comprises a polypropylene glycol.

8. The composition according to claim 1, comprising at least 0.5 wt. % of polyamide fibers.

9. The composition according to claim 1, comprising up to 6 wt. % of polyamide fibers.

10. The composition according to claim 1, wherein the length of the polyamide fibers is from 0.1 to 7 mm and their diameter is from 10 to 100 μm.

11. The composition according to claim 1, wherein the titer of the polyamide fibers is from 1 to 100 dtex.

12. The composition according to claim 1, wherein the polyamide fibers are selected from Nylon, Perlon, Akulon, Aramid fibers.

13. The composition according to claim, wherein the polyamide fibers consist of Nylon 6.6.

14. The composition according to claim 1, comprising 0 to 10 wt. % of auxiliaries, which are selected from at least one of thickeners, thixotropes, catalysts, defoamers, wetting agents, stabilizers, colorants, lightweight fillers, optical brighteners, solvents and UV absorbers.

15. The composition according to claim 1, comprising less than 1 wt. % of organic solvent.

16. The composition according to claim 1, wherein said composition when adhesively bonding substrates is almost non-foaming hardly foams at all during curing.

17. A process for manufacturing a composition according to claim 1, in which at least one NCO-terminated polyurethane prepolymer, prepared from at least one polyol compound and at least one polyisocyanate, is mixed with polyamide fibers and at least 10 wt. % of fillers.

18. (canceled)

19. An adhesion process for the almost non-foaming adhesion of substrates with a 1-component polyurethane adhesive composition comprising polyamide fibers, in which a first surface to be adhesively bonded is coated with the adhesive composition, is pressed onto a second surface to be adhesively bonded, and the adhesive is then left to cure without the use of clamps or presses.

20. The adhesion process according to claim 19, wherein the achieved adhesive bond between two beech wood test specimens exhibits a tensile shear strength of at least 2.0 N/mm².

21. Use of an adhesive composition according to claim 1, for adhesively bonding materials such as wood, wood materials, mineral substrates, metals, paper, cardboard, leather, textiles, fiber fleeces, natural fibers, synthetic fibers or plastics.

22. A method of reducing foaming of a 1-component polyurethane adhesive composition, comprising:
providing at least one NCO-terminated polyurethane prepolymer, prepared from at least one polyol compound and at least one polyisocyanate; and
mixing polyamide fibers and at least 10 wt. % of fillers to the prepolymer to form the adhesive composition;
wherein the adhesive composition comprising polyamide fibers foams less during curing than a similar adhesive composition without polyamide fibers.
